(19) United States
(12) Patent Application Publication
(10) Pub. No.: US 2013/0305266 A1
(43) Pub. Date: Nov. 14, 2013

(54) SLOT-IN TYPE OPTICAL DISK DRIVE

(71) Applicant: QUANTA STORAGE INC., Taoyuan County (TW)

(72) Inventors: Jen-Chen WU, Taoyuan County (TW); Yu-Sheng Wang, Taoyuan County (TW)

(73) Assignee: QUANTA STORAGE INC., Taoyuan County (TW)

(21) Appl. No.: 13/764,159

(22) Filed: Feb. 11, 2013

(30) Foreign Application Priority Data
May 8, 2012 (CN) 201210140598.5

(51) Int. Cl. G11B 17/051

(52) U.S. Cl. CPC G11B 17/051
USPC 720/605

(57) ABSTRACT

A slot-in type optical disk drive is disclosed. An inclined flange is protruded on the lower end of a guide pin. When ejecting a disc, a power unit moves a slider backward to push a shifting lever at one end of a detecting rod. The detecting rod is rotated to move the guide pin at the other end such that the inclined flange pushes the back edge of the disc to ascend along the inclined flange to avoid jamming.

This application claims the benefit of People's Republic of China application Serial No. 201210140598.5, filed May 8, 2012, the subject matter of which is incorporated herein by reference.

### BACKGROUND OF THE INVENTION

1. Field of the Invention

The invention relates in general to a slot-in type optical disk drive, and more particularly to a disc ejection device of a slot-in type optical disk drive, which reads/writes data from/into a medium disc with laser light.

2. Description of the Related Art

The slot-in type optical disk drive rotates a roller with power to automatically load or eject a disc. After having been exposed in a high temperature environment, improperly stored, or used over a long period of time, the thin disc made of plastic material may easily be deformed, such that the slot-in type optical disk drive cannot eject the disc smoothly.

An optical disk drive is disclosed in the US Patent Publication No. U.S. Pat. No. 8,060,897. As indicated in FIG. 1, the slot-in type optical disk drive 10 of prior art utilizes power to rotate the roller 11. A guide strip 13 is fixed on the casing 12. When a disc 14 is loaded into the slot-in type optical disk drive 10, the disc 14 is retained between the roller 11 and the guide strip 13 and is automatically pushed to the interior of the slot-in type optical disk drive 10 by a friction force generated from the rotation of the roller 11 to touch the detecting rod 15 and activate a transmission unit of the slot-in type optical disk drive 10. The transmission unit rises up the spindle motor 16 and pushes down the clamping device 17, restrains the disc 14 by the central hole 18, and at the same time pushes down the roller 11 to come off the disc 14. Then, the spindle motor 16 rotates the disc 14 to read/write data. When the slot-in type optical disk drive 10 has completed the reading/writing of data and needs to eject the disc 14, the spindle motor 16 is pushed down while the clamping device 17 ascends, the disc 14 is released and the roller 11 ascends. The roller 11 and the guide strip 13 together clamp the disc 14. The roller 11 is reversely rotated for pushing the disc 14 off the slot-in type optical disk drive 10, such that the disc 14 can be conveniently ejected.

The slot-in type optical disk drive 10 may smoothly eject a disc 14 with ordinary appearance but may not smoothly eject a deformed disc 14a denoted by dotted lines as indicated in FIG. 1. The deformed disc 14a is bowl-shaped, that is, the deformed disc 14a is warped at the peripheral edge and is depressed at the center. When ejecting the deformed disc 14a, the depressed central hole 18 of the deformed disc 14a cannot be effectively lifted to come off the spindle motor 16 because the deformed disc 14a is clamped by the roller 11 and the guide strip 13. Consequently, the central hole 18 of the deformed disc 14a is engaged with the back edge of the spindle motor 16, and the disc 14 cannot be smoothly ejected from the slot-in type optical disk drive 10. Therefore, the slot-in type optical disk drive of the prior art still has many problems to tackle with when it comes to ejecting a deformed disc.

### SUMMARY OF THE INVENTION

The invention is directed to a slot-in type optical disk drive. When ejecting a disc, an inclined flange protruded on the lower end of a guide pin of a detecting rod is ascended along with a clamping device to lift the disc such that the disc can be smoothly ejected.

According to one embodiment of the present invention, a slot-in type optical disk drive is disclosed. A roller is disposed in an entrance at the front end of a drive module and is rotated by a power unit which drives a slider to slide and bring a traverse disposed inside the drive module and a spindle motor disposed on the traverse to ascend/descend. Meanwhile, the slider drives the roller to ascend/descend in a direction opposite to the ascending/descending direction of the traverse. A clamping device is fixed at the rear end of the drive module, and comprises a supporter connected to a clamping base. One end of the supporter is fixed at the drive module and used as a pivot, such that the clamping base at the other end of the supporter ascends/descends along with the supporter. A detecting rod is pivotally disposed on the supporter. A guide pin is disposed at one end of the detecting rod. The other end of the detecting rod forms a shifting lever contacting one end of the slider. The slider brings a guide bevel to lean on the supporter such that the supporter ascends/descends along the guide bevel. A casing covers the drive module. A guide strip is disposed at a position opposite to the roller.

According to the slot-in type optical disk drive of the present invention, an inclined flange of the detecting rod is protruded on the lower end of a guide pin. When the slot-in type optical disk drive ejects a disc, the power unit moves a slider backward to push a shifting lever at one end of a detecting rod. The detecting rod is rotated to move the guide pin at the other end such that the inclined flange pushes the back edge of the disc to ascend along the inclined flange. When the slot-in type optical disk drive ejects a disc, the guide pin ascends along the supporter, and the inclined flange pushes the back edge of the disc to move upward to avoid jamming.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a cross-sectional view of a slot-in type optical disk drive of the prior art;

FIG. 2 shows an explosion diagram of a slot-in type optical disk drive of the present invention;

FIG. 3 shows a partial enlargement diagram of a region A of FIG. 2;

FIG. 4 shows a cross-sectional view of a slot-in type optical disk drive of the present invention in a loading state;

FIG. 5 shows a cross-sectional view of a slot-in type optical disk drive of the present invention in a playing state; and

FIG. 6 shows a cross-sectional view of a slot-in type optical disk drive of the present invention in an ejection state.

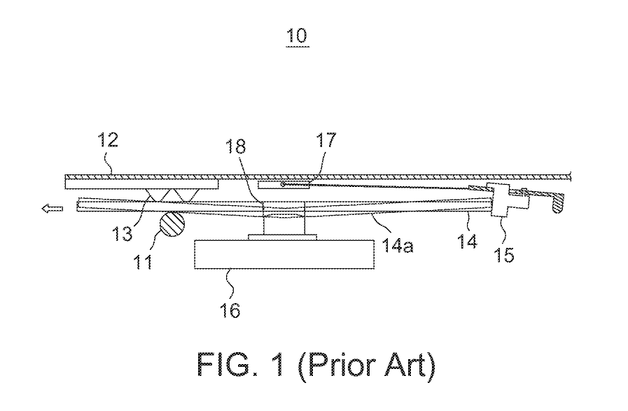

### DETAILED DESCRIPTION OF THE INVENTION

The technologies used in the present invention to achieve the above objects and the effects of the technologies are exemplified by a number of exemplary embodiments taken in conjunction with the accompanying drawings.

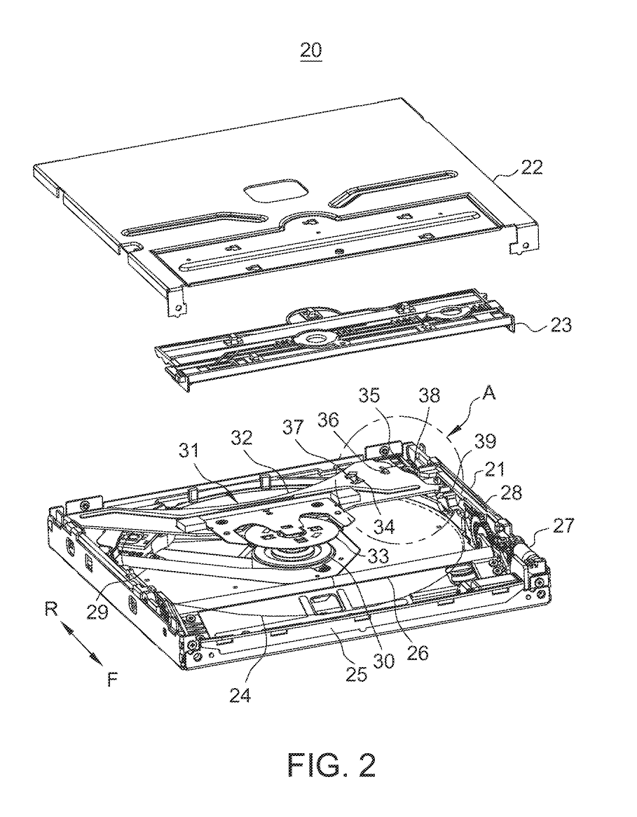

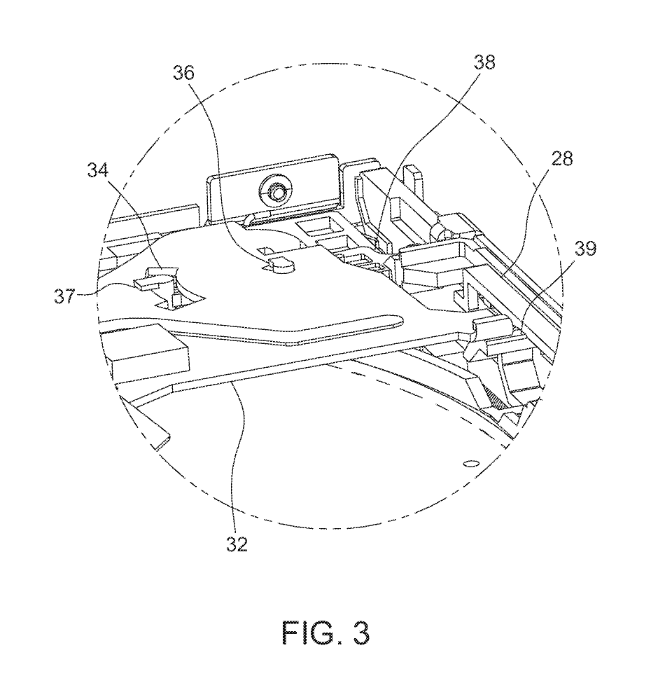

Referring to both FIG. 2 and FIG. 3. FIG. 2 shows an explosion diagram of a slot-in type optical disk drive of the present invention. FIG. 3 shows a partial enlargement diagram of a region A of FIG. 2. The slot-in type optical disk drive 20 of the present invention includes a drive module 21, a casing 22 and a guide strip 23. A roller 26 is disposed at the entrance 25 of the drive module 21, and is rotated by a power unit 27 of the drive module 21. The casing 22 covers the drive module 21, and a guide strip 23 is disposed oppositely to the roller 26. The power unit 27 further moves a slider 28 to slide and bring the traverse 29 disposed inside the drive module 21 to ascend/descend, such that the spindle motor 30 disposed on the traverse 29 ascends/descends accordingly. Meanwhile, the slider 28 drives the roller 26 to ascend/descend in a direction opposite to the ascending/descending direction of the traverse 29.

In the drive module 21, the end at which the entrance 25 is disposed is referred as the front end F, and the end opposite to the entrance 25 is referred as the rear end R. A clamping device 31 is fixed at the rear end R of the drive module 21. The clamping device 31 comprises a supporter 32 connected to a clamping base 33. One end of the supporter 32 is fixed on the drive module 21 and is used as a pivot allowing the supporter 32 to be limitedly rotated up and down, such that the clamping base 33 disposed at the other end of the supporter 32 is driven to ascend or descend accordingly. A fulcrum 36 of a detecting rod 35 is pivotally disposed on the supporter 32, such that the detecting rod 35 can be rotated via the fulcrum 36. A inclined flange 40 is protruded on the lower end of the guide pin 37 at one end of the detecting rod 35, and the other end of the detecting rod 35 extends from a lateral side of the supporter 32 to form a shifting lever 38 contacting one end of the slider 28. The slider 28 brings a guide bevel 39 to lean on the supporter 32, such that the supporter 32 can be limitedly rotated up and down along the guide bevel 39.

The detecting rod 35 can be directly pivoted on the supporter 32 and become fixed. However, to make the detecting rod 35 more smoothly rotated, the supporter 32 can have an arc hole 34 which the guide pin 37 at one end of the detecting rod 35 passes through and moves along.

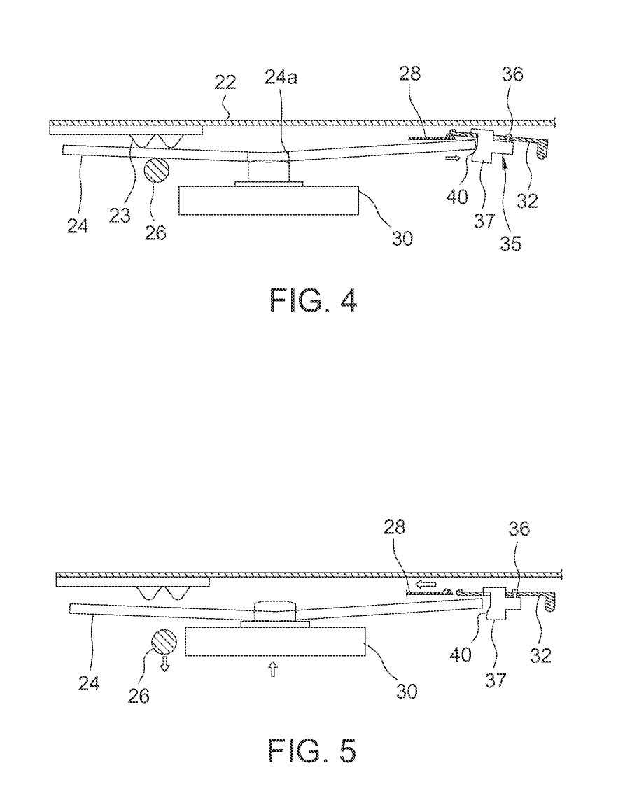

Referring to FIG. 2, FIG. 4 and FIG. 5. FIG. 4 shows a cross-sectional view of a slot-in type optical disk drive of the present invention in a loading state. FIG. 5 shows a cross-sectional view of a slot-in type optical disk drive of the present invention in a playing state. When the disc 24 is loaded into the slot-in type optical disc drive 20 (as indicated in FIG. 4), the disc 24 is restrained by the roller 26 and the guide strip 23, and is pushed to the interior of the slot-in type optical disk drive 20 by the friction force generated from the rotation of the roller 26. The edge of the disc 24 moves backward to push the guide pin 37 of the detecting rod 35, such that the guide pin 37 is moved backward along the arced hole 34. The detecting rod 35 is rotated via the fulcrum 36 and brings the shifting lever 38 at the other end to move forward to push the slider 28, and further activates the power unit 27 to move the slider 28 forward. The slider 28 brings a guide bevel 39 to move forward, such that when the supporter 32 leaning on the guide bevel 39 descends along the guide bevel 39, the clamping base 33 descends accordingly. When the slider 28 is moved forward, the slider 28 concurrently brings the spindle motor 30 disposed on the traverse 29 to ascend and clamp the disc 24 by the central hole 24a together with the clamping base 33, and the rotating roller 26 is pushed down to come off the disc 24 to complete the loading procedure such that the spindle motor 30 rotates the disc 24 to enter a playing state (as indicated in FIG. 5). The slot-in type optical disk drive 20 in the playing state can be ejected by executing the above procedure in an inverse sequence. The loading/ejection device and procedure of the slot-in type optical disk drive 20 can be found in generally known technologies and are not technical features of the present invention. The related details can be found in the US patent disclosed in the prior art, and are not repeated here.

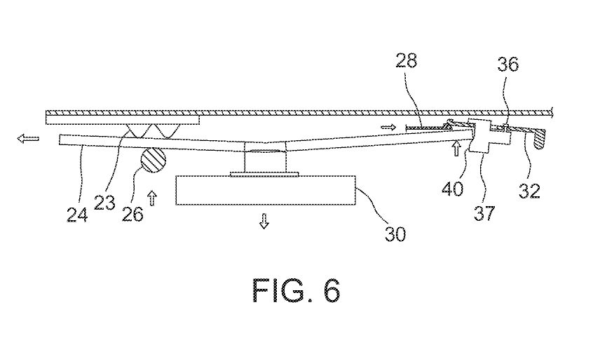

Referring to FIG. 2 and FIG. 6. FIG. 6 shows a cross-sectional view of a slot-in type optical disk drive of the present invention in an ejection state. The present invention modifies the loading/ejection device of the slot-in type optical disk drive of the prior art by protruding a inclined flange 40 on the lower end of the guide pin 37 of the detecting rod 35. The ejection procedure can be executed by the slot-in type optical disk drive 20 to stop the playing state. Firstly, the spindle motor 30 stops rotating the disc 24. Secondly, the power unit 27 reversely rotates the roller 26, and moves the slider 28 backward. The slider 28 moved backward rises up the roller 26, and further restrains the disc 24 together with the guide strip 23. The slider 28 moved backward concurrently brings a guide bevel 39 to move backward, such that the supporter 32 leaning on the guide bevel 39 ascends along the guide bevel 39, and the clamping base 33 also ascends. Besides, the slider 28 moved backward also brings the spindle motor 30 disposed on the traverse 29 to descend, such that the disc 24 can be released. If the released disc 24 has an abnormal appearance and is jammed, the slider 28 being continually moved backward pushes the shifting lever 38 at one end of the detecting rod 35, such that the detecting rod 35 is rotated via the fulcrum 36 to move the guide pin 37 at the other end forward to touch the disc 24. The inclined flange 40 protruded on the lower end of the guide pin 37 leans on the back edge of the disc 24, and guides the back edge of the disc 24 to ascend along the inclined flange 40. Meanwhile, the guide pin 37 also ascends with the supporter 32, and the inclined flange 40 pushes the back edge of the disc 24, such that the disc 24 is freed from jamming and can be smoothly ejected from the slot-in type optical disk drive 20.

According to the slot-in type optical disk drive of the present invention, an inclined flange is disposed at the lower end of a guide pin of the detecting rod for guiding the back edge of the jammed disc to ascend along the inclined flange. Meanwhile, when the guide pin ascends with the clamping device, the back edge of the disc is risen up, so that the disc is freed from jamming and the disc can thus be smoothly ejected.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A slot-in type optical disk drive, comprising:
a drive module, wherein a roller is disposed in an entrance at the front end of the drive module and is rotated by a power unit, the power unit drives a slider to slide and bring a traverse disposed inside the drive module and a spindle motor disposed on the traverse to ascend/descend, the slider drives the roller to ascend/descend in a direction opposite to the ascending/descending direction of the traverse, a clamping device is fixed at the rear end of the drive module, and comprises a supporter connected to a clamping base, one end of the supporter is fixed at the drive module and used as a pivot, such that the clamping base at the other end of the supporter ascends/descends along with the supporter; a detecting rod is pivotally disposed on the supporter, a guide pin is disposed at one end of the detecting rod, and the other end of the detecting rod forms a shifting lever contacting one end of the slider, and the slider brings a guide bevel to lean on the supporter such that the supporter ascends/descends along the guide bevel;
a casing covering the drive module, wherein a guide strip is disposed at a position opposite to the roller;
wherein, an inclined flange of the detecting rod is protruded on the lower end of a guide pin, and when the slot-in type optical disk drive ejects a disc, the power unit moves the slider backward to push the shifting lever at one end of the detecting rod which is rotated to move the guide pin at the other end such that the inclined flange pushes the back edge of the disc to ascend along the inclined flange to avoid jamming.

2. The slot-in type optical disk drive according to claim 1, wherein the supporter has an arc hole which the guide pin disposed at one end of the detecting rod passes through and moves along.

3. The slot-in type optical disk drive according to claim 1, wherein when the slot-in type optical disk drive ejects the disc, the guide pin ascends with the supporter such that the inclined flange pushes the back edge of the disc to move upward.
